(19) United States
(12) Patent Application Publication
(10) Pub. No.: US 2016/0343042 A1
(43) Pub. Date: Nov. 24, 2016

(54) MILITARY-VETERAN DONATION CARD SYSTEM & PROGRAM

(71) Applicants: Tameka Rachelle Peoples, Lompoc, CA (US); Debra Ann Peoples, Lompoc, CA (US)

(72) Inventors: Tameka Rachelle Peoples, Lompoc, CA (US); Debra Ann Peoples, Lompoc, CA (US)

(21) Appl. No.: 15/158,417

(22) Filed: May 18, 2016

Related U.S. Application Data
(60) Provisional application No. 62/164,356, filed on May 20, 2015.

(51) Int. Cl. G06Q 30/02; G06Q 20/34

(52) U.S. Cl. CPC G06Q 30/0279; G06Q 20/356; G06Q 50/26

(57) ABSTRACT

A system for funding a MMBC, MWR, chosen veteran non-profit, and traditional non-profit organization includes a community proprietary coded donation card. There are a plurality of related fundraising activities are operated by the MMBC, MWR. The profits made by MMBC, MWR through the donation card program will be to support and promote comradership (morale) of persons and family of persons who are members of the Armed Forces, a funding mechanism for a veteran via choice selection of non-profit donation options, as well as a model for other non-profit corporations. A distribution system is configured to provide funding allocation of donations regardless of program with times, percentage, and cancellation options of participation for vendor. An approved affiliate for external business interface is configured to: receive applications for onboarding businesses, accept the application for the onboarding businesses and receive revenue from the onboarding the businesses to the donation card programs.

### RELATED APPLICATION

This application claims priority to provisional patent application U.S. Ser. No. 62/164,356 filed on May 20, 2015, the entire contents of which is herein incorporated by reference.

### BACKGROUND

The embodiments herein relate generally to systems and processes for donating cash to military, veteran/disabled veteran members. Prior to the disclosed invention/process, a military member booster club was a group of military members (active-duty) that provided support and promotion of comradership of persons who are or have been members of the Armed Forces i.e. active duty military assigned to a military installation and unit, and or to veterans and their local community. However, fund raising and operating of the military member booster clubs (MMBC) a 501(c)3 non-profit organization was inefficient, and limiting. Fundraising for veterans/disabled-war veterans experienced similar degrees of limitations and lack of cohesion, and frankly most traditional 501(c)3 corporations. The Embodiments of the disclosed system for the military and veteran donation card system/program will solve these problems. The program can also be the model for how other non-profit organizations can automate its fundraising capabilities i.e. schools, hospitals etc.

### SUMMARY

A system for fund raising for the MMBC includes a donation card. Distributed (given or sold), by a MMBC representative or the base morale welfare and readiness (MWR) representative. The donation card will be distributed to a verified military member's (MM's), a MM who presents, to the MMBC or MWR representative, a valid Department of Defense (DoD) common access card (CAC). The donation card will be configured with a community card code, captured within the participating vendors' credit card terminal/point-of-sale (POS) system. The donation card is configured to upon purchase to reserve a percentage of the price of purchase (i.e. 10%) into the merchants' credit card terminal/POS system, whereby the merchant has agreed to donate monthly the total amount in the reserved to Peoples Foundation for Connecting Community, Military, and Veteran's Services, Inc. a 501(c)19 (veteran-war group) organization per internal revenue code (IRC); via automatic clearing house (ACH) transfer. The merchant will have ability to donate for one-time fundraising event or on a reoccurring basis; also merchant can cancel at anytime with at least 30 days notice. Upon receipt of donation from merchant Peoples Foundation for Connecting Community, Military, and Veteran's Services, Inc. will transfer via ACH or wire transfer 100% of amount (less donation card processing fees) to the MMBC. The profit made from the donation to the MMBC, will go to provided support and promotion of comradership (morale) of persons who are or have been members of the Armed Forces i.e. active duty military assigned to a military installation and unit, and or to veteran's and their local community. The MMBC, retained earnings will be limited based on their identified budget, their requirement for cash reserves for one years operating expenses, DoD service level instruction requirements, and all excess funding will either go to MWR, DoD or Service level fundraising campaigns as identified in the MMBC by-laws. The veteran donation card program will work similarly card will be distributed to veteran possessing a Veteran Health Identification Card (VHIC) via VA or validated thro Peoples Foundation. The veteran will have choice of veteran non-profit organization's to support with its monthly distributions; choices will include Department of Veteran of Affairs, Wounded Warrior Project or Disabled American Veterans. All card holders of military and the veteran donation card program will be considered members of Peoples Foundation. At all times the MMBC will be configured to state and federal non-profit organizations legal formation requirements. Peoples Foundation for Connecting Community, Military & Veteran's Services Inc. and its approved affiliates: ABF Precision Consultants, LLC, Peatra's Executive Marketing Group J155, Faithworks Enterprises: ABF Precision Consultants, LLC, Peatra's Executive Marketing Group J155, Faithworks Enterprises, will act as external business interface and be configured to: receive applications for onboarding businesses who want to participate in donation card program, accept the application for the onboarding businesses and receive revenue, through donation card swipe fees, of participating businesses.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic view of one embodiment of the present invention.

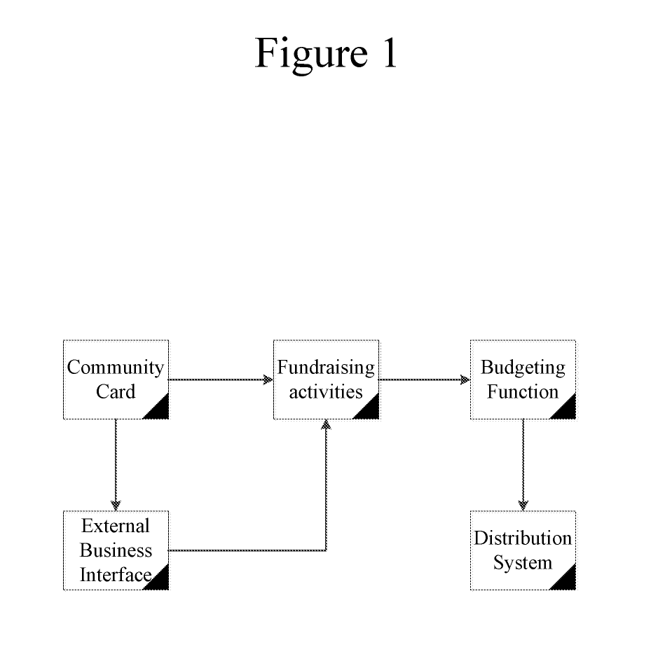

### DETAILED DESCRIPTION OF CERTAIN EMBODIMENTS

one embodiment of the present system comprises a donation card, distributed to a military/veteran member. The donation card is configured to provide a reserve holding, upon purchases, distributed on agreed upon monthly donation basis to Peoples Foundation and a transfer equal to (donation card processing fees) to the participating MMBC boost. will go to provided support and promotion of comradership of persons who are or have been members of the Armed Forces i.e. active duty military assigned to a military installation and unit, and or to veteran's and their local community is used to fund the booster club. The MMBC, retained earnings will be limited based on their identified budget, their requirement for cash reserves for one years operating expenses, DoD service level instruction requirements, and all excess funding will either go to MWR, DoD or Service level fundraising campaigns as identified in the MMBC by-laws. Peoples Foundation for Connecting Community, Military & Veteran's Services Inc. and its approved affiliates: ABF Precision Consultants, LLC, Peatra's Executive Marketing Group J155, Faithworks Enterprises: ABF Precision Consultants, LLC, Peatra's Executive Marketing Group J155, Faithworks Enterprises, will act as external business interface and be configured to: receive applications for onboarding businesses who want to participate in donation card program, accept the application for the onboarding businesses and receive revenue, through donation card swipe fees, of participating businesses.

In both embodiments of the donation card the card is configured and governed by the federal and state law for a non-profit corporation. By implementing state/federal law procedures for tracking donations, providing receipts and reporting earnings. Further this will enable the donations made by participating merchants to be tax deductible as well as the contributions received from the donation card program to be tax deductible.

To accomplish the steps of this system and program, the MMBC would need to update its bylaws, to be signed by military member commander, to be incompliance with all state and federal non-profit and tax-exempt status/filings. The MMBC, will need to identify a budget to include required reserves, excess fund allocations, fundraising limitation times to account for DoD/Service level fund raising times, institute the required state and federal non-profit accounting processes. The DoD, will have an option to identify if the program implementation will be maintained by the individual MMBC or base MWR. Which ever path is chosen the organization MMBC or MWR will need to identify a budget to include required reserves, excess fund allocations, fundraising limitation times to account for DoD/Service level fund raising times, institute the required state and federal non-profit accounting processes. The MMBC or MWR, would have option to order enough card(s) for it's members or club, or issue them. The MWR, will be able to support this as a base level program depending on program adoption preferences, whereby allowing the cards to be sold or given out on base at it's facilities to CAC cards holders. The Peoples Foundation for Community, Military & Veteran's Services will have a MMBC development team, program management team to support implementation of the military program. The implementation team, will have to have the required guidance updates depending on if MWR will implement the program. Peoples Foundation approved affiliates: ABF Precision Consultants, LLC, Peatra's Executive Marketing Group J155, Faithworks Enterprises: ABF Precision Consultants, LLC, Peatra's Executive Marketing Group J155, Faithworks Enterprises will work with participating vendors to develop their donation preferences and program can be employed on local or national level. Donation options will be able to support military member morale needs such as: Going away, Christmas/Thanksgiving family support needs. Donation options by the MMBC, can be tailored as coordinated, by Peoples Foundation implementation team, with vendor to meet MMBC needs. The donation card processing team uses a contracted proprietary software/platform implementation team that will make cards compatible with all vendor POS nationwide and globally as needed. Our software team can upgrade vendors terminal/POS software for seamless card integration.

The DoD, Department of Veteran Affairs, and or other military/veteran non-profit organizations to include traditional non-profit organizations can use this method to solve several problems. For one the military would use it to support providing a solution to military member retention issues, low morale of members, multiple tours of duty, stress from doing less with more work life balance issues which has been linked to high suicide rates in the military. While supporting the increasing desire by commercial industries' desire to support the military and veterans this includes the desire to support traditional non-profits. Instituting this program would remove the ambiguity from commercial vendors and determining who is or is not a “military” member or veteran. As this program, puts the validation of a military/veteran member to the military and veteran department. Imposing the necessary updates to MMBC state and federal non-profit tax exempt requirements will limit the exposure/liability to the volunteer military members, and allow for the use/employment of a consumer based model similar to the: AFFES/MWR applied to the commercial sector, based on the military members consumer activity to fund facility needs. This model, will use that model and apply it to companies off of military installations. The veteran program uses same model and solves the problem of the need for donated funds to support veteran rehabilitative services and needs; as well as other veteran non-profit organizations to receive needed donated funds to support veteran needs. The military and veteran card program, or any other 501(c)3 corporation, enables a donation model that supports a merchants tax write off options as it relates to IRC 501(c), specifically 501(c)19 veteran organization with war group tax-exempt status assigned by the state and internal revenue service (IRS) for Peoples Foundation for Connecting Community, Military & Veteran's Services. The merchant will also have the ability to adjust donation limits based on tax limit needs or cancelation from program as desired.

A figure conceptually illustrates the military, veteran, or any non-profit 501(c) donation card process for the Peoples Foundation, contracted proprietary electronic system that will process donation card transaction's to be donated at the end of the month. The process leverages current “reward or loyalty” card processing, via Peoples Foundation contracted proprietary system and software. The donation can be processed with some embodiments of credit card terminal/POS systems or internet-protocol (IP) platforms. The credit card terminal/POS system, will be required to have compatible software of the proprietary processing team. All credit card terminals/POS will be updated, and those who won't allow software updates can use the IP based options. The IP based option can be used on multiple electronic systems which may be a personal computer, laptop computer, tablet or other mobile devices to include a phone.

The credit card terminal/POS system will track percentage of purchase price, and reserve the amount to the merchant accounting system (back-end accounting platform). When merchant creates accounting settlement at end of month, the amount in the community card account for military, veteran or other non-profit card program will be donated (minus card processing fees), via ACH, to the non-profit, IRC 501(c)19* war group, Peoples Foundation for Connecting Community, Military & Veteran's Services. This process collectively represents the donation process. All system, peripheral, and chipset buses that communicatively connect the numerous internal devices of the electronic system that will process the donation will vary.

From these various memory units, the processing unit(s) retrieves instructions to execute and process funds through ACH routing to the donation to the non-profit. The processing unit(s) may be a single processor or a multi-core processor in different embodiments.

The vendors credit card terminal/POS or IP based platform may have a read-only-memory (ROM) or mass-storage device, computers will vary in process speed and technology.

The merchant's credit card terminal/POS, or computer and associated accounting systems will connect via local area network (LAN) to the internet. Through the internet connection the merchant will use ACH to transfer and donate funds to Peoples Foundation, and will pay all associated transaction/accounting fees for processing of community card.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. §112, ¶6. In particular, any use of “step of” in the claims is not intended to invoke the provision of 35 U.S.C. §112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for funding a military member booster club-regardless of implementation choice, that provides support and promotion of comradeship (morale) of persons and family of persons who are members of the Armed Forces i.e. active duty military assigned to a military unit, a funding mechanism for a former member of the Armed Forces (a veteran) via choice selection of non-profit donation options, as well as a model for other non-profit 501(c) corporations; the system comprising:
a community card coded by contracted proprietary software company, distributed to a person (military member, veteran, or non-profit); wherein the merchant agreed upon donation percentage is configured to provide a donation to Peoples Foundation for Connecting Community, Military & Veteran's Services; whereby Peoples Foundation will donate the maximum possible to MMBC, MWR, chosen veteran non-profit, or traditional non-profit corporation;
a plurality of related fundraising activity is conducted by MMBC, MWR, veteran non-profits, and traditional nonprofit corporations businesses; wherein the profit is used to fund the MMBC, MWR, veteran non-profits, and traditional nonprofit needs;
a MMBC or MWR will maintain a budget, retained earnings limit enough to support reserves for a year, limitation of fundraising times in accordance with all DoD and service level guidance;
a adaptable proprietary distribution system; configured to provide funding settlement times via ACH, desired percentage amounts, ability for cancelation of participation, adjustable for fundraising events desired by the MMBC, MWR, veteran chosen non-profit, and traditional non-profit corporation, a payment for service process;
an approved affiliated external business interface; wherein the external business interface is configured to: receive applications for onboarding businesses, accept the application for the onboarding businesses and receive revenue from the onboarding businesses to the donation card programs.
